(19) United States
(12) Patent Application Publication
(10) Pub. No.: US 2010/0248200 A1
(43) Pub. Date: Sep. 30, 2010

(54) System, Method and Computer Program for Virtual Reality Simulation for Medical Procedure Skills Training

(76) Inventors: Hanif M. Ladak, London (CA); Sumit Kishore Agrawal, London (CA); Murad Husein, London (CA); Brian Wheeler, London (CA)

Correspondence Address: MILLER THOMPSON, LLP, Scotia Plaza, 40 King Street West, Suite 5800, TORONTO, ON, M5H 3S1, CA

(21) Appl. No.: 12/566,902

(22) Filed: Sep. 25, 2009

Related U.S. Application Data
(60) Provisional application No. 61/100,374, filed on Sep. 26, 2008.

(51) Int. Cl. G09B 23/28

(52) U.S. Cl. 434/262

(57) ABSTRACT

The present invention discloses a virtual reality medical procedure skills training simulator, particularly to be used in the field of ear-nose-throat surgery such as myringotomy. The simulator consists of medical procedural tools marked with physical markers, a tracking device to track the marker, a stereo display device to simulate a medical procedural microscope, and a computer system to enable the simulation.

### FIELD OF THE INVENTION

The present invention relates to medical procedure skills training. The present invention more specifically relates to virtual reality simulation for medical procedure skills training purposes.

### BACKGROUND OF THE INVENTION

Traditionally, medical procedures including surgery are taught through the apprenticeship model and then through rotating residency. In the apprenticeship model, the inexperienced surgeon generally watches an experienced surgeon perform surgery, and then the inexperienced surgeon performs one. Using this technique, surgical residents gain experience and improve their technique by performing surgery on real patients. However, any mistakes they make in learning and any problems they encounter can result in permanent injury to a real, live patient.

Myringotomy is the most frequently performed otolaryngology surgical procedure. It is also typically the first surgery experienced by new ear, nose and throat (ENT) residents. Having enough hand-eye coordination training to perform myringotomies is very important to the safety of the patient. Nevertheless, many new surgeons do not have the motor skills necessary to perform this surgery.

Another surgical procedure is otoscopy, which refers to visual examination of the ear canal and eardrum for disease. An otoscope, which consists primarily of an eyepiece and illumination source, is inserted into the ear canal to aid in visualization. In pneumatic otoscopy, puffs of air are also applied to induce movement of the eardrum in an attempt to better diagnose the pathology and its effects on eardrum mechanics. Trainees are taught otoscopy through lectures, textbooks and limited interaction with patients. In lectures and textbooks, static images are used to teach about disease appearance. The images used are of the entire eardrum, whereas in practice, a physician can only visualize a small portion of the eardrum and must move the otoscope and mentally integrate a set of partial views to arrive at a diagnosis. Experience with patients is limited to the particular cases that present during training.

Simulators are often used to train people for tasks that would otherwise be prohibitively dangerous and/or expensive. Applications for simulators range from airline pilot training and military drills to surgery training. In these tasks, simulators have been very successful. Flight simulators are used to train commercial airline pilots, and simulators have previously been vital training platforms for space missions such as the moon landings. Within the field of surgery, laparoscopic procedure simulations are becoming common while simulators for other surgeries have not been as fully developed.

Creating a training simulator has many advantages over traditional instructional methods.

A simulated environment can easily mimic different situations. For example, adult and infant ear canal geometries, the amount of infection present in the middle ear, and abnormal ear canal shapes are all examples of aspects that could be easily produced and modified in a surgical simulator. These different scenarios can be useful to train surgeons for unusual cases.

Another advantage of a simulator is the quickness with which one can change scenarios and repeat the task. Once a surgeon has completed the practice task, the task may be attempted again within a short time frame or at any other time the surgeon desires.

The prior art has disclosed some physical simulators for ear surgeries, however they typically consist of a tube with a synthetic membrane (e.g., film or paper) at one end. They are anatomically unrealistic and the mechanical properties are not accurate. In addition, they do not enable automatically providing quantitative feedback to trainees. Furthermore, none of the physical simulators presented in the prior art allow simulation of a surgical microscope to accurately simulate the surgery, such as is required for ear surgeries. There are other simulators where a microscope is used. For example, a Stanford simulator provides a temporal bone drilling simulator wherein a virtual head is placed under the microscope. However, the Stanford simulator is not useful for surgeries on the eardrum and middle ear as it does not simulate these structures. It cannot be used for myringotomy.

Another common method is the physical grommet trainer (also referred to as Bradford/Wigan grommet trainers). These involve a small plastic tube with a plastic or latex membrane at one end. This allows the surgeon to practise making the incision and inserting a grommet. However, these models are limited to a single ear canal geometry, generally must be replaced or repaired after each use, and do not provide quantitative metrics.

Virtual reality simulators can improve the performance of surgeons in their operating tasks and significantly reduce the amount of errors surgeons make in performing surgeries. Used mostly for training purposes in minimally invasive laparoscopic surgeries and other operations that require fine motor skills and hand-eye coordination, virtual reality simulators have been quite successful. Another use of virtual reality simulation is in determining the abilities and potential of doctors to perform these surgeries.

There also exist software simulators for microvascular surgeries. In these types of simulators, 3D geometry and a great degree of precision are required. However, the geometry of these surgeries is not as complicated as that of a typical ear surgery.

The prior art does not address the challenges overcome by the present invention.

U.S. Pat. No. 6,770,080 to Kaplan teaches a guide structure that can mechanically register a treatment probe with a target region of a target tissue, the guide structure being fittingly received in an auditory canal and often comprising a conformable body such as a compressible foam, or the like. However, Kaplan does not teach any type of simulator to allow training for such a surgery.

U.S. Pat. No. 5,997,307 to LeJeune, Jr. teaches a medical teaching apparatus enables medical students, physicians, and surgeons to hone their skills of examination and surgical procedures upon the human ear. However, the apparatus LeJeune, Jr. teaches does not allow a surgeon to immediately reattempt a simulation, nor does the apparatus allow for dynamic modification of the properties of the ear, such as canal shape and size.

U.S. Pat. No. 6,241,526 to Auran et al. teaches a device for training physicians in tympanocentesis wherein the device includes an outer member resembling a side profile of a child's head and shoulder's area, and cartridges are supplied to simulate aspects of the inner ear, most notably the eardrum. However, the device taught by Auran does not allow for dynamic modification of the properties of the ear, such as canal shape and size.

U.S. patent application 20010008756A1 by Auran et al. teaches a similar device as U.S. Pat. No. 6,241,526 with the same limitations described above.

U.S. Pat. No. 6,725,080 to Melkent et al. teaches an image-guided surgical navigation system for facilitating the combined positioning and orientation of multiple surgical implements. However Melkent does not teach a simulation method allowing for learning by surgeons.

In addition, none of the above cited inventions teach a system and method that allows for quantitative and objective metrics to provide feedback on the accuracy of a surgeon's skills when performing a surgery.

What the prior art has failed to disclose is a surgical simulation system and method that can provide for simulation of movement within very small areas, such as the ear canal. In such small areas, a high degree of accuracy and resolution are required that are not addressed in the prior art.

Therefore, what is required is a system and method for a virtual reality myringotomy training simulator. The simulator should be designed to improve the basic motor skills and hand-eye coordination needed by surgeons to perform the delicate ear surgery. What is also required is a surgical simulator that could be extended to any type of surgery, particularly those requiring the use of a surgical microscope.

### SUMMARY OF THE INVENTION

The present invention provides a computer-implemented medical procedure simulation training and evaluation method comprising the steps of: (a) one or more users engaging a simulation system to initiate a medical procedure simulation routine, by means of one or more computer processors, the simulation system being linked to one or more medical procedural tools, or a simulation thereof, and a three dimensional motion tracking device for tracking manipulation of the one or more medical procedural tools, or the simulation thereof, the simulation system defining or implementing one or more performance parameters associated with procedurally acceptable manipulation of the one or more medical procedural tools; and (b) by operation of the simulation system, providing feedback to the user regarding his/her accuracy of manipulation of the one or more medical procedural tools, or simulation thereof, based on the one or more performance parameters, and thereby improving the user's accuracy of manipulation of the one or more medical procedural tools through repetition by the user of the medical procedure simulation.

The present invention also provides a simulation system for medical procedure skills training and evaluation comprising: (a) a simulation computer; (b) a simulation program linked to the simulation computer, or otherwise made available to the simulation computer, the simulation program embodying a computer simulation of a particular medical procedure that requires accuracy in manipulating a medical procedural tool, the computer simulation including one or more performance parameters related to the manipulation of one or more medical procedural tool, or a simulation thereof, by one or more users; (c) a motion tracking utility linked to the simulation computer, said motion tracking device operable to track the motion of the one or more medical procedural tools, or simulation thereof; and (d) a feedback utility for providing feedback to one or more users regarding their manipulation of the one or more medical procedural tools, or simulation thereof; wherein the simulation computer, motion tracking utility and feedback utility co-operate to enable the user to develop medical procedure skills by initiating one or more computer simulations, and receiving feedback based on his/her performance in the one or more computer simulations based on the performance parameters.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### DESCRIPTION OF THE DRAWINGS

FIG. 1 illustrates a virtual reality medical procedure skills training system in accordance with the present invention.

FIG. 2 illustrates an optical tracking system and mock microscope for implementing the medical procedure skills training system.

FIG. 3 illustrates an optical tracking system in one aspect of the present invention.

FIG. 4 illustrates a virtual reality stereo display device operable to simulate a surgical microscope in one aspect of the present invention.

FIG. 5 illustrates an environment simulating an ear canal and eardrum in one aspect of the present invention.

FIG. 6 illustrates a myringotomy simulator comprising a haptic arm.

FIG. 7 illustrates a trainee using an otoscopy simulator in accordance with the present invention.

FIG. 8 illustrates a close up view of the simulator screen previously illustrated in FIG. 7.

### DETAILED DESCRIPTION

The present invention discloses a system, method and computer program for virtual reality simulation for screening, medical procedure skills training, and medical procedural certification. The present invention may be used, for example, to evaluate applicants before allowing them to join medical residency programs; suggest to applicants not having the required hand-eye coordination for performing medical procedures under a microscope to choose alternative medical specialties; train residents without jeopardizing the safety of the patient; record and review the performance of the trainee by senior surgeons and other senior physicians; and/or occasionally certify the skills of practicing surgeons and physicians in the otolaryngology departments. The present invention may be used to simulate a surgery or a non-surgical medical procedure.

Examples that implement the system of the present invention include, but are not limited to, simulations of myringotomy, otoscopy, tympanoplasty, ossiculoplasty and stapedotomy. However, it is to be understood that the invention is in no way limited to medical procedures of the ear, or to medical procedural procedures in general. For example, the present invention can also be implemented for training laboratory technicians, or any other field in which there is a high degree of required hand-eye coordination and use of high precision tools.

The present invention may be considered to consist of two main parts. First, a simulator, designed and created as described in part by the representative embodiments set out below. Second, metrics may be provided to a physician to validate the skills of the physician.

### Myringotomy Simulator

A myringotomy simulator must be designed to provide physicians and medical students with a realistic environment in which they are able to develop the skills necessary to perform medical procedures. Several different components must be managed and combined together to produce an effective simulation.

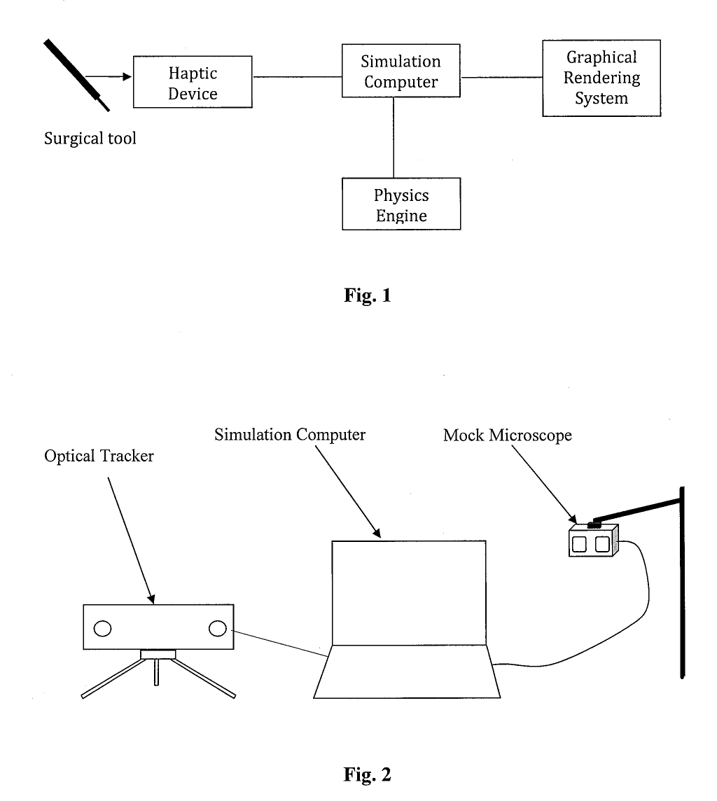

FIG. 1 illustrates a virtual reality medical procedure skills training system in one aspect of the present invention. The system of the present invention may include tools to simulate medical procedural tools, a motion tracking system, a feedback device, and a simulation computer hosting a software physics engine, and a graphical rendering system. The system may also include input devices such as a keyboard and/or mouse to enable the manipulation of simulation settings. Optionally, the present invention may also include a haptic device, which may for example be a haptic arm, providing physical feedback to the physician.

The feedback device may be any type of visual, auditory, or other sensory device that is operable to provide the physician with information regarding the progress of the medical procedural simulation. For example, in one aspect of the present invention, the feedback device may be a 3D stereo display device. The 3D stereo display device is further described below. In another aspect of the present invention, the feedback device may be an auditory device operable to generate sounds relating to the 3D spatial location of the tools and the target area that is the subject of the medical procedure.

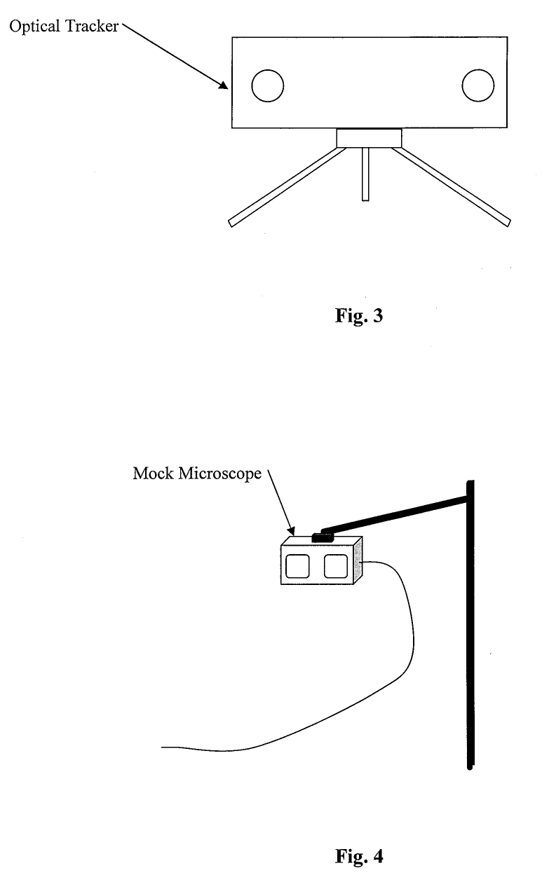

FIG. 2 illustrates an optical tracking system and mock microscope for implementing the medical procedure skills training system. FIG. 3 illustrates an optical tracking system in one aspect of the present invention. A micro-tracker may be used for tracking the motion of the medical procedural instrument. This device may consist of a pair of cameras for stereo vision and imaging software for recognizing a visual marker on the medical procedural tool to determine its location in 3D space. It should be understood that other technologies for motion tracking may be used.

In one aspect of the present invention, the maximum speed of the camera may be set to 30 frames processed per second. Where running at 60 frames per second, the simulation may read the tool position data from the camera every other frame.

A visual motion tracker may allow the simulator the use of a medical procedural tool with minimal modification. The medical procedural tool may simply require a paper marker, or other physical marker, attached to it so that it can be identified by the tracker. Specifically, the tip of the blade of a tool, a curette, and/or a speculum may be marked. A plurality of markers may be used so that the orientation of the tools may be determined. Alternatively, the system may include one marker of a size substantial enough to enable orientation tracking.

It is also possible to use other methods of tracking or motion detection within the system of the present invention, such as magnetic tracking, acoustic tracking, inertial tracking, or a haptic device. Where a haptic device, which may for example be a haptic arm, is used, the haptic device may be associated with the medical procedural tools such that movement of the medical procedural tools enables equivalent movement of the haptic device. An implementation of the present invention comprising a haptic device is described more fully below.

FIG. 4 illustrates a virtual reality stereo display device operable to simulate a surgical microscope in one aspect of the present invention. The display device may be thought of as a mock microscope consisting of a 3D stereo virtual reality head set, or other stereo display device operable to simulate a surgical microscope. The display device, such as the head set, may have two displays. Using the example settings described above wherein 30 frames are processed per second, the display device may be set to refresh at 30 Hz, for a total of 60 rendered frames per second.

The system may be oriented such that it simulates use of a surgical microscope during surgery. The display device may be mounted on an adjustable stand. Use of a stand may allow the angle and position of the microscope simulator to be adjusted. The simulation software may be associated with motion sensors and configured such that adjustment of the angle or position of the stand results in corresponding adjustments in the simulation software. The display device may sit above and to the right of the motion tracker, or at any other desired location since the mounting stand may be adjustable. The positioning may allow the tracking camera to observe the surgical instrument at all times while the virtual surgery is being performed.

The simulation software may consist of several parts. It may either be a custom developed application built using object oriented design or be built upon open source objects. This may allow the code to be structured and allow for the ease of replacement of components such as physics engines. To use the simulation software, all of the hardware devices must be properly connected to a simulation computer.

The simulation software components may include open source objects. For example, the Object-Oriented Graphics Rendering Engine™ (OGRE) may be used to render the objects to the screen and the Open Dynamics Engine™ (ODE) may be used for collision detection and physics calculations. Additionally, Object-Oriented Input System™ (OIS) may be used for capturing input devices such as a mouse and/or keyboard.

The selection of open source objects may enable the low cost production of the simulator that is the subject of the present invention. Cost may be a consideration. The general availability of laptop or home computers may enable the widespread availability of the simulator of the present invention. This may be especially beneficial in an educational environment. Furthermore, the simulator may be provided to students without the simulation computer, such that a student could borrow the device and install the appropriate simulation software on a personal computer for use outside of the school or hospital.

However, open source components are not required, as substantially similar applications would achieve a similar result, potentially but not necessarily at a higher cost.

The graphical rendering software may first generate an image of a circular tube without a bend to simulate the ear canal. Alternately, the canal may be rendered with a bend to represent an adult ear canal. The angle, curvature, and location of the bend may be set in the simulator.

Next, a graphical representation of the eardrum with certain landmarks (such as to represent bones used as reference points) may be generated. The generated images may or may not be required to be three dimensional images, as the eardrum (the subject of the medical procedure) is similar to a flat plane. Alternatively, a high resolution image may be textured over a three dimensional mesh to imitate depth.

The graphical representations may then be displayed to the physician on the display device.

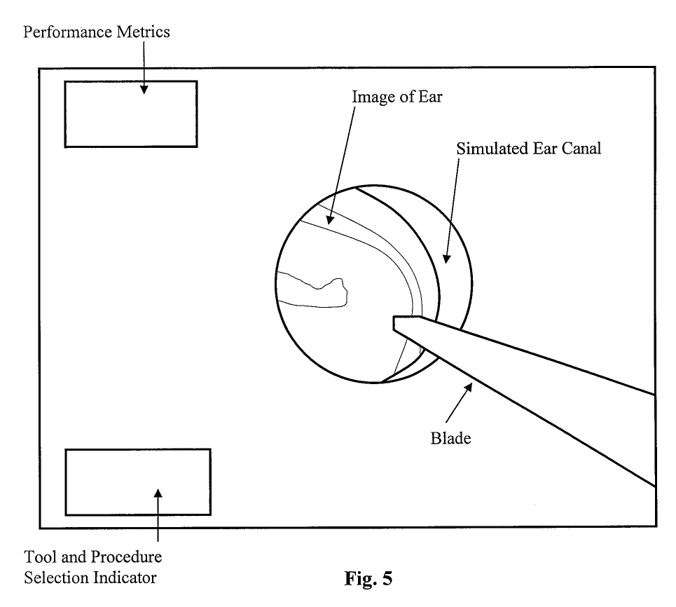

FIG. 5 illustrates an environment simulating an ear canal and eardrum in one aspect of the present invention. As illustrated in FIG. 5, all of these components combine to create a cohesive virtual reality surgical environment. A surgeon may look into the microscope simulator and see the simulated ear canal and eardrum in front of them. They may manipulate these objects with the surgical tool and speculum (each with tracking device attached) just as when performing an actual myringotomy.

Optionally, the simulated images may be customized by the surgeon or any other person configuring the simulator. For example, the size and shape of the ear canal or eardrum may be modified. Bulges may be made to appear on the eardrum, and the bulges may be configured to contain liquid, have a certain degree of redness, or in some other way indicate a diseased state. Furthermore, liquid behind an eardrum may be made to add viscosity that could impact the simulated incision.

Additionally, visual markers may be placed on the eardrum to help train the surgeon on the appropriate incision points. For example, the visual markers could represent the incision points or could represent points that must not be cut.

Furthermore, it may be possible to adjust the difficulty of the simulation over a range to allow surgeons to compare their skills to actual surgeries and also give them sufficient challenge. For example, incision accuracy, size of the ear canal, or number of helpful cues (such as incision placement indicators) may be adjusted.

Finally, use of a partial mannequin could be enabled such that the system performs as a hybrid physical/virtual implementation. This may require that the simulation be set up to match the mannequin's ear canal dimensions.

### Performing the Simulation

The myringotomy procedure is performed on all age groups, from infants to the elderly. The patient is generally placed on an operating table and a funnel-like device called a speculum is placed on their ear. The use of the speculum does not affect the simulation since it does not limit the size of the opening (ear canal), but rather increases it. Therefore, the simulation parameters may be set to assume the use of a speculum without requiring its physical or simulated presence. Alternately, a speculum could be placed under the surgical microscope if desired. Use of a speculum in the simulation may enhance the realism provided by the simulation, as a speculum is commonly used in otologic surgery for a variety of procedures, including, but not limited to, myringoplasty, tympanoplasty and ossiculplasty

The next step in a physical myringotomy is use of a tool to remove the ear wax in some cases. The surgeon may optionally include this step in the simulation, in which case the tool is provided with a visual tracking marker or other visual tracking means as described above.

Next, the microscope is focused onto the eardrum. Since the simulator surgical microscope is placed on an arm, the surgeon is able to mimic a real surgical environment in this step.

The surgeon may then begin to insert the blade into the ear canal. The surgeon must guide the blade without touching the eardrum or sides of the ear canal. Optionally, the simulator may be set to display an optimal path, which can be displayed in the surgical microscope as described below. Contact with the eardrum or the ear canal may cause the simulator to simulate bleeding, which may require the surgeon to remove the blood, causing a delay in completing the surgery. It is notable that myringotomies are generally scheduled for approximately 30 minutes, and such a delay has a non-negligible impact on the surgeon's performance success. This information may be given to the surgeon in the metrics described below.

The surgeon, if successful in navigating the ear canal, must then cut the appropriate area of the eardrum, being the anterior inferior quadrant. As described below, this area may be displayed on the microscope with visual indicators for training purposes.

In addition to the incision area, the incision depth is also important. An overly deep incision may cut bone behind the eardrum or cause other damage. The simulator may provide feedback on the depth of the cut. Where the option of a haptic device is used, feedback may be provided for hitting a bone or other object behind the eardrum.

### Metrics

Quantitative metrics provided by a simulated environment are needed for structured training. Giving a physician numerical scores for their performance during a simulated medical procedure allows consistent, objective evaluations of a physician's skill. Physicians can watch their own improvements measuring themselves over time and compare their scores to those of other physicians.

The metrics provided by the present invention may include data including how long it takes to navigate the ear canal, the path taken through the ear canal (in other words, how accurately the physician followed a certain desired trajectory rather than simply avoiding the canal walls) and, for a surgical procedure, where the incision was made, the depth of the incision, and the size of the incision.

The metrics may be non-binary, that is, they need not be limited to successful and unsuccessful but rather may represent a spectrum of numerical scores to the physician. For example, there could be analysis of the contact area.

Some example metrics that may be provided to the physician include, but are not limited to: total number of errors, including for example accidentally cutting the virtual ear canal and targeting the wrong location on the eardrum; the time to completion of a myringotomy; orientation of the incision (radial versus circumferential); length of incision; current viewpoint of the mock microscope and visibility of the eardrum; instrument angulation; physical forces; degree of blind cutting; level of confidence; and/or systematic progression.

Force feedback may also be provided. The force could be proportional to the degree of to which the tissue is pushed with the tools. There could also be proportional feedback whereby the trajectory is recorded, and the simulator is enabled to play back and give the physician material to review once the simulation is complete. The physician could use this data, for example, to determine whether errors were caused by tremor in their hands or something else. Recorded data could be amplified if required, to simplify analysis by a physician.

### Haptic Device

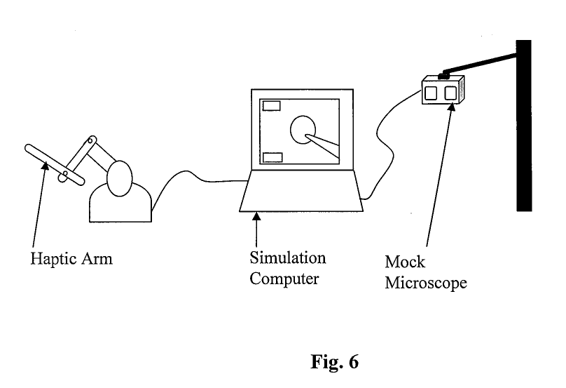

As previously mentioned, the present invention may comprise a haptic device, which may for example be a haptic arm. The haptic device may replace or augment the optical tracking system. FIG. 6 illustrates a myringotomy simulator comprising a haptic arm.

A haptic device allows the position and orientation of its end effector to be tracked in real time and can be used to control the spatial movement of a virtual medical procedural tool. Unlike an optical tracking system, a haptic device can also provide force feedback to simulate the forces experienced when a virtual medical procedural tool interacts with virtual tissue. The use of a haptic device may also enable the invention to be used without markers, which are used for tracking an optical tracking system, which may require visibility of the markers at all times.

For example, myringotomy typically involves the use of both hands and it is likely that the line of sight between the tracker and marker will become temporarily obscured. This could result in irregular rendering of the movement of virtual tools. A haptic device requires no markers and there is no line of sight.

The haptic device may be calibrated by asking one or more experienced physician or medical residents to touch all virtual tissues using a virtual medical procedural tool, which may for example be a virtual blade, controlled by the haptic device. The participants may adjust a “stiffness” parameter in the haptic model to achieve realistic rendering of force feedback.

### Otoscopy Simulator

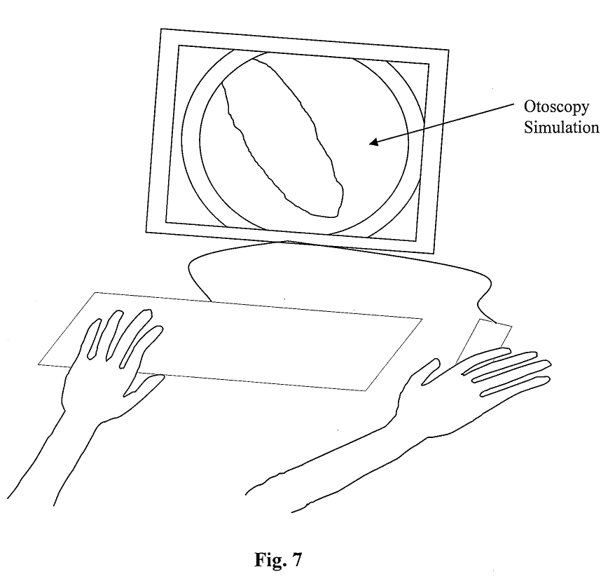

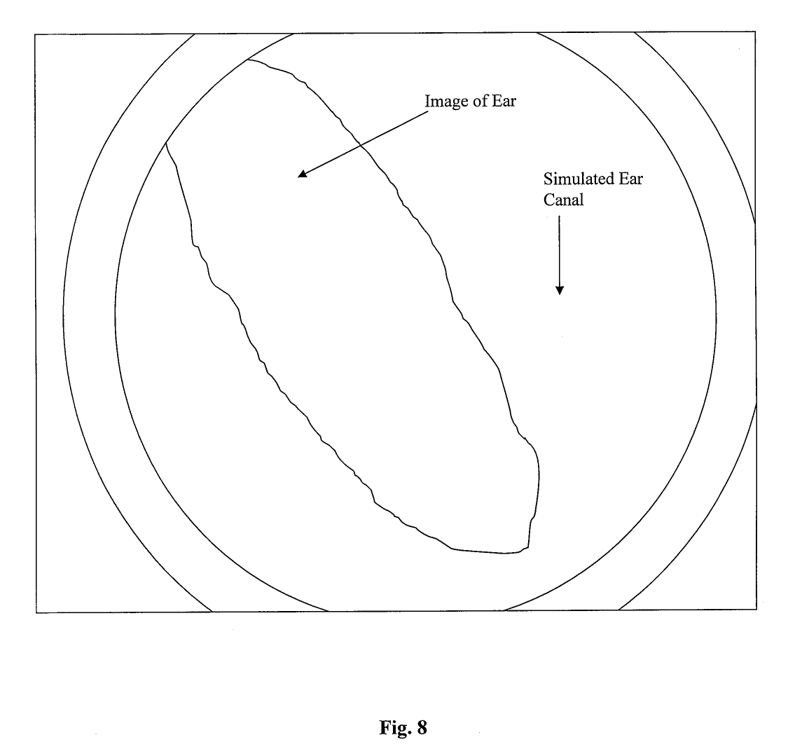

The present invention can also be implemented as an otoscopy simulator, which presents the trainee with a three dimensional visual model of the ear canal and eardrum. The implementation may be similar to that of the myringotomy simulator previously described, however the method of viewing may be changed to a monitor rather than simulated microscope and there may be no interaction with the virtual eardrum since no incision is needed. FIG. 7 illustrates a trainee using an otoscopy simulator in accordance with the present invention. FIG. 8 illustrates a close up, view of the simulator screen previously illustrated in FIG. 7.

The trainee can dynamically view portions of the model as in a real otoscopy. The simulator can display a healthy eardrum as well as real ear-canal and eardrum geometries of patient ears to simulate a variety of pathologies in order to test the abilities of trainees in recognizing diseases. In addition, real-time deformable models of the eardrum can be displayed to model pneumatic otoscopy.

Motion constraints imposed by the ear-canal wall on the virtual otoscope may be simulated via collision detection, and reaction forces of the ear-canal wall developed in response to collision with the virtual otoscope may be felt by the trainee via incorporation of a haptic device as previously described.

### Further Simulations

As mentioned above, the simulation system can be used for non-surgical medical procedures including, for example, tympanoplasty, ossiculoplasty, and stapedotomy.

These medical procedures involve the initial basic steps required in both otoscopy and myringotomy simulation. The trainee may place the speculum and use a virtual microscope in order to maximize visualization of the external auditory canal and tympanic membrane. The first step of raising a tympanomeatal flap may use medical procedural instruments similar to those used in myringotomy (blade and suction).

To model tympanoplasty, various types of grafting materials may be modeled to be placed underneath the tympanic membrane for repair. The soft tissue models for placement may be programmed to ensure realism.

In ossiculoplasty, detailed models of the middle ear space and ossicles (malleus, incus, and stapes) may be created. Movement of the ossicles and forces needed to remove them may be accurately modeled. Three-dimensional models of prosthesis (PORP and TORP) may also be created and the simulator may allow placement of these within the middle ear space.

In stapedotomy, the additional steps of cutting the stapedius tendon using scissors, fracturing the superstructure of the stapes, and drilling the small stapedotomy hole using a 0.6 mm skeeter drill may also be implemented. Finally, a stapes prosthesis may be modelled, placed into the stapedotomy, and crimped onto the incus in order to complete the procedure.

### Extensions

As could be envisioned by a person skilled in the art, the present invention could extend to any ear-nose-throat (“ENT”) medical procedures. Furthermore, the present invention could very easily extend to all aspects of ear procedures where the ear is accessed through the eardrum (the other option being from the outside, behind the ear). A non-exhaustive list of ENT procedures that may be included is: myringoplasty, tympanoplasty, ossiculoplasty, and canalplasty.

With minor modification, the present invention could be extended to non-ENT procedures, based on the rationale that the same simplified virtual reality environment for navigation/targeting, combined with feedback could be used. A non-exhaustive list of non-ENT procedures that may be included is any procedure involving navigation through a tube such as sinus surgery; some endoscopic applications such as rigid bronchoscopy; any surgery involving cutting of membranes such as retinal surgery; and any surgery where a surgical microscope must or could be used such as microvascular surgery.

Furthermore, the present invention can also be implemented for training laboratory technicians, or any other field in which there is a high degree of required hand-eye coordination and use of high precision tools.

It should be understood that some surgeries are conducted by more than one surgeon. The present invention can be used to provide surgery skills training to multiple surgeons in relation to such multi-surgeon surgeries.

1. A computer-implemented medical procedure simulation training and evaluation method comprising the steps of:
(a) one or more users engaging a simulation system to initiate a medical procedure simulation routine, by means of one or more computer processors, the simulation system being linked to one or more medical procedural tools, or a simulation thereof, and a three dimensional motion tracking device for tracking manipulation of the one or more medical procedural tools, or the simulation thereof, the simulation system defining or implementing one or more performance parameters associated with procedurally acceptable manipulation of the one or more medical procedural tools; and
(b) by operation of the simulation system, providing feedback to the user regarding his/her accuracy of manipulation of the one or more medical procedural tools, or simulation thereof, based on the one or more performance parameters, and thereby improving the user's accuracy of manipulation of the one or more medical procedural tools through repetition by the user of the medical procedure simulation.

2. The method as claimed in claim 1 wherein the motion tracking device is a haptic device associated with the one or more medical procedural tools, or the simulation thereof, the method comprising the further step of providing force feedback to the user by means of the haptic device, said force feedback providing resistance when the one or more medical procedural tools, or simulation thereof, make contact with a simulated surface.

3. The method as claimed in claim 1 wherein the motion tracking device includes a plurality of cameras and imaging software linked to the simulation program.

4. The method as claimed in claim 1 wherein the medical procedure simulation routine is based on a myringotomy.

5. The method as claimed in claim 1 wherein the medical procedure simulation routine is based on a medical procedure selected from the group consisting of: tympanoplasty, ossiculoplasty, stapedotomy, canalplasty, sinus surgery, bronchoscopy, retinal surgery, and microvascular surgery.

6. The method as claimed in claim 1, comprising the further step of providing a graphical rendering of one or more visual indicators to assist in medical procedure skills training.

7. The method as claimed in claim 6 wherein the visual indicators relate to an ear canal and an eardrum.

8. The method as claimed in claim 1, comprising the further step of configuring or modifying the performance parameters.

9. The method as, claimed in claim 1 wherein the computer simulation includes three-dimensional geometry of an anatomical area where the medical procedure requires manipulation in three dimensions of the one or more surgical tools.

10. The method as claimed in claim 7, comprising the further step of configuring or modifying the size of the ear canal, number and placement of the one or more visual indicators, or incision.

11. The method as claimed in claim 6 wherein the one or more visual indicators display an optimal path for performing the medical procedure.

12. The method as claimed in claim 1 wherein the performance parameters are based on objective, quantitative metrics for performance of the medical procedure.

13. The method as claimed in claim 12 wherein the one or more performance parameters are selected from the group consisting of: time taken to perform a medical procedure; the path traveled by the one or more medical procedural tools; and the location, path, depth, and size of an incision.

14. A simulation system for medical procedure skills training and evaluation comprising:
(a) a simulation computer;
(b) a simulation program linked to the simulation computer, or otherwise made available to the simulation computer, the simulation program embodying a computer simulation of a particular medical procedure that requires accuracy in manipulating a medical procedural tool, the computer simulation including one or more performance parameters related to the manipulation of one or more medical procedural tool, or a simulation thereof, by one or more users;
(c) a motion tracking utility linked to the simulation computer, said motion tracking device operable to track the motion of the one or more medical procedural tools, or simulation thereof and
(d) a feedback utility for providing feedback to one or more users regarding their manipulation of the one or more medical procedural tools, or simulation thereof;
wherein the simulation computer, motion tracking utility and feedback utility co-operate to enable the user to develop medical procedure skills by initiating one or more computer simulations, and receiving feedback based on his/her performance in the one or more computer simulations based on the performance parameters.

15. The system claim in claim 14 wherein system enables the user to improve his/her medical procedure skills through repetition of the computer simulation.

16. The system claim in claim 14 wherein system enables evaluation of the user by a third party for the purposes of screening the user as a physician.

17. The system claim in claim 14 wherein system enables evaluation of the user by a third party for the purposes of certification of the user as a physician.

18. The simulation system as claimed in claim 14 wherein the simulation program includes a physics engine, and a graphical rendering utility.

19. The simulator system as claimed in claim 14 wherein the simulation computer is further associated with a keyboard and a mouse.

20. The simulator system as claimed in claim 14 wherein the motion tracking utility includes a haptic device associated with the one or more medical procedural tools, or simulation thereof.

21. The simulator system as claimed in claim 20 wherein the haptic device provides force feedback to the user, said force feedback providing resistance when the medical procedural tools make contact with a simulated surface.

22. The simulator system as claimed in claim 14 wherein the motion tracking utility includes a plurality of cameras and imaging software associated with the simulation program.

23. The simulator system as claimed in claim 22, wherein one or more physical markers are attached to the one or more medical procedural tools, or simulation thereof, the one or more physical markers enabling tracking of the one or more medical procedural tools, or simulation thereof, by the motion tracking utility.

24. The simulator system as claimed in claim 14 wherein the medical procedure consists of a myringotomy.

25. The simulator system claimed in claim 14 wherein the surgical skills training is for a medical procedure selected from the group consisting of: tympanoplasty, ossiculoplasty, stapedotomy, canalplasty, sinus surgery, bronchoscopy, retinal surgery, and microvascular surgery.

26. The simulator system as claimed in claim 14 wherein the simulation system is operable to provide a graphical rendering of one or more visual indicators to assist in medical procedure skills training.

27. The simulator system as claimed in claim 26 wherein the visual indicators relate to an ear canal and an eardrum.

28. The simulator system as claimed in claim 14 wherein the parameters may be configured and modified.

29. The simulator system as claimed in claim 14 wherein the computer simulation includes three-dimensional geometry of an anatomical area where the medical procedure requires manipulation in three dimensions of the one or more medical procedural tools.

30. The simulator system as claimed in claim 28 wherein the size of the ear canal, number and placement of the one or more visual indicators, and incision accuracy may be configured and modified.

31. The simulator system as claimed in claim 26 wherein the one or more visual indicators display an optimal path for performing the medical procedure.

32. The simulator system as claimed in claim 14 wherein the performance parameters are based on objective, quantitative metrics for performance of the medical procedure.

33. The simulator system as claimed in claim 14 wherein the one or more performance parameters are selected from the group consisting of: time taken to perform a medical procedure; the path traveled by the one or more medical procedural tools; and the location, path, depth, and size of an incision.

34. The method as claimed in claim 1 wherein the surgical simulation routine is based on an otoscopy.
